(19) United States
(12) Patent Application Publication
(10) Pub. No.: US 2015/0115542 A1
(43) Pub. Date: Apr. 30, 2015

(54) RING SEAL WITH A DOUBLE STEP SEALING JOINT

(71) Applicant: Deere & Company, Moline, IL (US)

(72) Inventor: CLAYTON P. NEUMANN, CEDAR FALLS, IA (US)

(73) Assignee: Deere & Company, Moline, IL (US)

(21) Appl. No.: 14/067,111

(22) Filed: Oct. 30, 2013

(51) Int. Cl. F16J 15/16

(52) U.S. Cl. CPC F16J 15/16
USPC 277/546

(57) ABSTRACT

A ring seal includes a pair of end portions which engage each other in overlapping relationship. Each end portion includes first, second and third fingers which extend along an arc from a body of the seal. The second finger is adjacent to and radially inwardly with respect to the first finger and is shorter than the first finger. The first and second fingers form a Z-shaped seal surface which faces perpendicularly to the axis. The third finger is shorter than the second finger, and is positioned radially outwardly of the second finger. The end portions have complimentary mirror image relationship to each other so that they engage in overlapping relationship. Each finger forms a corresponding radially extending end surface. The body forms a radially extending shoulder. Each finger also forms a corresponding radially inwardly facing side surface. The first and third side surfaces are spaced radially outwardly with respect to the second side surface.

### FIELD

The present disclosure relates to a sealing ring for sealing between a housing and a shaft which rotates in the housing.

### BACKGROUND

It is known to place a ring shaped seal in a groove in a rotating shaft. In some situations, function or space limitations require that the sealing ring be located in a groove in the housing. There are many different types of seal ring joints that have been used over the years, such as the butt joint, the bias joint, the hook joint and the double step joint. Such ring seals may be obtained from suppliers such as the Grover Corporation. See http://www.grovercorp.com/rings-and-seals/. However, such joint designs cannot be used when the sealing ring is in a housing groove because it is not possible to assemble the ring. It is desired to provide a ring seal which has a joint which allows the seal to be assembled into a housing groove and which eliminates direct leak paths through the joint.

### SUMMARY

According to an aspect of the present disclosure, a ring seal has a pair of end portions. The end portions are complimentary with respect to each other so that they engage each other in overlapping relationship. The ring has a square cross-sectional shape so that each end portion is divided into four equal quadrants. Three of the quadrants form corresponding first, second and third fingers, each having a different length. Thus, each end portion has a first, second and third finger, each of which extends along an arc from a body of the seal. The arc has a central axis. The second finger is adjacent to and radially inwardly with respect to the first finger, and is shorter than the first finger. The first and second fingers form a seal surface which faces perpendicularly with respect to the axis. The third finger is shorter than the second finger, and is positioned radially outwardly with respect to the second finger,

Each finger forms corresponding radially extending end surface, and the body forms a radially extending shoulder surface which is joined to the second and third fingers. The second end surface is located between the first end surface and the third end surface. The third end surface is located between the second end surface and the shoulder surface.

Each finger also forms a corresponding radially inwardly facing first, second and third side surface. The first and third side surfaces are spaced radially outwardly with respect to the second side surface. The second side surface is an extension of a radially inner surface of the body.

### BRIEF DESCRIPTION OF THE DRAWINGS

FIG. 1 is a perspective view of a ring seal embodying the invention; and

FIG. 2 is an enlarged view of a portion of FIG. 1.

### DETAILED DESCRIPTION OF THE DRAWINGS

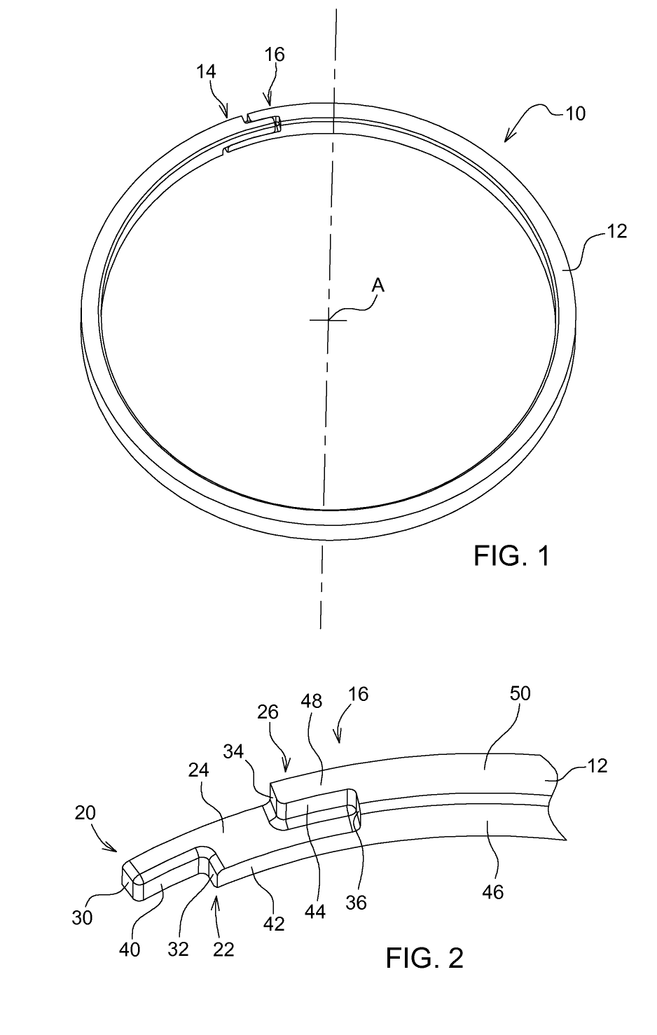

Referring to FIGS. 1 and 2, a ring seal 10 has a circular main body 12 and a pair of end portions 14 and 16. The end portions are complimentary with respect to each other so that they engage each other in overlapping relationship.

End portion 16 includes a first finger 20 which extends along an arc from the body 12 of the seal, the arc having a central axis A. A second finger 22 extends along an arc from the body 12. The second finger 22 is adjacent to and radially inwardly with respect to the first finger 20, and is shorter than the first finger 20. The first and second fingers 20 and 22 form first seal surface 24 which faces axially and perpendicularly with respect to the axis A. Seal surface 24 has a generally Z-shape. A third finger 26 extends along an arc from a body 12. The third finger 26 is shorter than the second finger 22. The third finger 26 is positioned radially outwardly with respect to the second finger 22 and is joined to seal surface 24.

The first finger 20 forms a first end surface 30 which extends radially. The second finger 22 forms a second end surface 32 which extends radially. The third finger 26 forms a third end surface 34 which extends radially. The body 12 forms a shoulder surface 36 which extends radially and which is joined to the second and third fingers.

The first finger 20 forms a first side surface 40 which faces radially inwardly. The second finger 22 forms a second side surface 42 which faces radially inwardly. The third finger 26 forms a third side surface 44 which faces radially inwardly. The first side surface 40 and the third side surface 44 are spaced radially outwardly with respect to the second side surface 42. The second side surface 42 forms a smooth transition or forms an extension of the radially inner surface 46 of the body 12. The third finger 26 also forms an axially facing fourth side surface 48. The forth side surface 48 forms a smooth transition or forms an extension of the axially facing side surface 50 of the body 12.

The result is a ring seal with a double step sealing joint design which permits the ring seal to used in a seal grove which in the housing instead of on the rotating shaft. This seal joint provides an overlapping joint structure which eliminates direct leak paths without forcing an assembler to “tuck” the last part of the seal being assembled behind the first part of the seal, when using a spiral or helical assembly technique to get the seal into a housing groove.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

I claim:

1. A ring seal having a pair of end portions which engage each other in overlapping relationship, each end portion comprising:
a first finger extending along an arc from a body of the seal, the arc having a central axis;
a second finger extending along an arc from a body of the seal, the second finger being adjacent to and radially inwardly with respect to the first finger and being shorter than the first finger, the first and second fingers forming a first seal surface which faces perpendicularly with respect to the axis; and
a third finger extending along an arc from a body of the seal, the third finger being shorter than the second finger, the third finger being positioned radially outwardly with respect to the second finger, the end portions are complimentary with respect to each other so that they engage each other in overlapping relationship.

2. The ring seal of claim 1, wherein:
the first finger forms a first end surface which extends radially;
the second finger forms a second end surface which extends radially;
the third finger forms a third end surface which extends radially; and
the body forms a shoulder surface which extends radially and which is joined to the second and third fingers.

3. The ring seal of claim 2, wherein:
the second end surface is located between the first end surface and the third end surface.

4. The ring seal of claim 3, wherein:
the third end surface is located between the second end surface and the shoulder surface.

5. The ring seal of claim 1, wherein:
the first finger forms a first side surface;
the second finger forms a second side surface;
the third finger forms a third side surface; the first and third side surfaces being spaced radially outwardly with respect to the second side surface.

6. The ring seal of claim 5, wherein:
the first side surface, the second side surface and the third side surface all face radially inwardly.

7. The ring seal of claim 5, wherein:
the second side surface is an extension of a radially inner surface 46 of the body.

8. A ring seal having a pair of end portions which engage each other in overlapping relationship, each end portion comprising:
a first end surface which extends radially;
a second end surface which extends radially;
a third end surface which extends radially; and
a shoulder surface which extends radially, the second end surface being located between the first end surface and the third end surface.

9. The ring seal of claim 8, wherein:
the third end surface is located between the second end surface and the shoulder surface.

10. The ring seal of claim 8, further comprising:
a first finger extending along an arc from a body of the seal, the arc having a central axis;
a second finger extending along an arc from a body of the seal, the second finger being adjacent to and radially inwardly with respect to the first finger and being shorter than the first finger, the first and second fingers forming a first seal surface which faces perpendicularly with respect to the axis; and
a third finger extending along an arc from a body of the seal, the third finger being shorter than the second finger, the third finger being positioned radially outwardly with respect to the second finger, the end portions being complimentary with respect to each other so that they engage each other in overlapping relationship.

11. The ring seal of claim 10, wherein:
the first finger forms a first side surface;
the second finger forms a second side surface; and
the third finger forms a third side surface; the first and third side surfaces being spaced radially outwardly with respect to the second side surface.
